(19) United States
(12) Patent Application Publication
(10) Pub. No.: US 2017/0333819 A1
(43) Pub. Date: Nov. 23, 2017

(54) FILTER CANDLE WITH MINERAL ADDITIVE

(71) Applicant: BWF Tec GmbH & Co. KG, Offingen (DE)

(72) Inventors: Thomas CARIUS, Heidenheim (DE); Martin DUNKEL, Günzburg (DE); Hans-Joerg IMMINGER, Offingen (DE)

(21) Appl. No.: 15/513,248

(22) PCT Filed: Sep. 17, 2015
(86) PCT No.: PCT/EP2015/001868

§ 371 Date: Mar. 22, 2017

(30) Foreign Application Priority Data
Sep. 24, 2014 (DE) 10 2014 014 164.0

(51) Int. Cl. B01D 39/20; B01J 23/70; B01D 46/24; B01J 29/00

(52) U.S. Cl. CPC B01D 39/2017; B01D 46/2407; B01J 23/70; B01D 39/2065; B01J 29/00; B01D 2239/0407

(57) ABSTRACT

The present invention relates to a filter candle element for the dedusting of industrial gases having improved properties concerning stability and environmental sustainability. This filter candle element comprises a filter body which is composed of inorganic fibers, and a mineral additive which is accumulated to the inorganic fibers. The mineral additive preferably comprises zeolite. Another aspect of the invention relates to a method of manufacturing a filter candle element for dedusting industrial gases. The method comprises the following steps: production of a slurry comprising inorganic fibers and a mineral additive; sucking in the slurry onto a suction core to form the filter candle element; drying of the formed filter candle element.

The subject matter of the invention is a filter candle element for dedusting industrial gases and a method of manufacturing such a filter candle element. In particular, the invention relates to a filter candle element with improved properties concerning the stability and environmental sustainability.

When dedusting industrial gases, on the one hand, bag filters are used and, on the other hand, filter candles are used. In the case of textile bag filters, the filter element is usually a cylindrical sleeve comprising a supporting tissue with fibers applied thereon as filter material. Bag filters are used for filtration at low and medium temperatures of up to 250° C. In contrast thereto, filter candles comprising a filter body made of inorganic fibers (such as ceramic fibers, vitreous fibers, high-temperature wool, carbon fibers) may be used for the filtration of gases up to 1000° C. The dust particles of the crude gas are predominantly deposited onto the surface of the filter candle.

Filter candles for industrial dedusting are used in numerous industrial areas. Thus, for example, the cement, glass or chemical industries produce gases and particulate matter containing sulfur or chloride, which can be filtered effectively by using filter candle elements.

During both the transport and installation phases and the operating phase, filter candle elements may be exposed to compressive loads in particular in the radial direction, and bending moments in particular in the longitudinal direction. The filter candle elements are particularly susceptible to said loads during the periods of transport and installation in the filter system. The filter candle elements may be damaged by e. g. concussions, shocks or vibrations and may even be destroyed under certain circumstances.

In addition, stricter and more stringent environmental protection requirements, on the one hand, call for the use of environmentally acceptable raw materials in the manufacture of the filter candle elements and, on the other hand, for the improvement of the filtration properties of the use filter candle elements.

It is known that the environmental protection requirements may partially be realized by increasing the length of the filter candle elements. This increases their throughput. However, it has a negative effect on the stability properties, since the weight of the filter candle elements and thus the tensile stresses to which they are exposed during the operating phase due to their own weight will increase. Moreover, the surface of known filter candle elements may subsequently be impregnated with catalytically active metal salt solutions. In addition to dedusting, this also allows denitrification of the gases. The known catalysts used (e. g. vanadium pentoxide), however, are toxic and environmentally not highly compatible.

The object of the present invention is to increase the stability of the filter candle element in an environmentally compatible manner, without having an adverse effect on the filtration performance.

Said object is solved by the filter candle element comprising the features according to claim 1. Advantageous embodiments of the present invention are indicated in subclaims 2 to 7. The method of manufacturing the filter candle element according to the invention is illustrated in claim 8. Advantageous embodiments of the method according to the invention are indicated in subclaims 9 and 10.

The filter candle element according to the invention for dedusting industrial gases comprises a filter body composed of inorganic fibers and a mineral additive accumulated to the inorganic fibers. Due to the fact that the mineral additive is accumulated to the inorganic fibers, the strength and compression stability of the filter body is increased. In particular, the radial compression stability and the bending moment in the longitudinal direction are increased. The use of a mineral additive has the advantage of increased environmental compatibility of the filter candle element. The inorganic fibers used preferably include mineral fibers, high-temperature wool, vitreous fibers, AES fibers or carbon fibers. Silica sand, rock flour, lime or zeolite are preferably used as mineral additive. The above cited substances are environmentally compatible raw materials that do not pose any health risks. This has the advantage that handling of the filter candle element is safe for humans. Another advantage is to be seen in the ease of disposal of the filter candle element.

The inorganic fibers are advantageously arranged in a fiber matrix. Arranging the fibers to form a three-dimensional matrix produces a porous structure of the filter body. Because of this structure, on the one hand, dust particles are retained in the filter body, and on the other hand, the dedusted gas may penetrate the fiber matrix of the filter candle element and be sucked off. Furthermore, arranging the fibers to form a fiber matrix also increases both the mechanical stability and the thermal resistance of the filter candle element. It is a further advantage if the mineral additive is distributed uniformly in the fiber matrix. On the one hand, this increases the stability of the filter candle element by accumulating the mineral additive on the fibers of the fiber matrix. On the other hand, parts of the cavities of the fiber matrix may be filled, which additionally contributes to a stiffening of the filter body.

The mineral additive expediently has a weight amounting to 1% to 8% of the weight of the filter body, preferably 2% to 6% of the weight of the filter body. Limiting the quantity of added mineral additive, on the one hand, has the advantage that both the bending moment of the filter body in the longitudinal direction and the radial compression stability of the filter body are increased significantly. On the other hand, limiting the quantity of added mineral additive prevents the porosity and the air permeability of the filter body (so-called filter resistance) from being reduced considerably. This prevents an increased pressure loss in the passage of the gas through the filter candle element (so-called pressure loss or Δₚ behavior). That is to say, a mineral additive has not yet a noticeable effect on the differential pressure behavior in the filtering process. The porosity of the filter candle element is preferably at least 80%. Above this value, said pressure loss does not have a significant effect on the filtration properties of the filter candle element. Another advantage of limiting the quantity of the added mineral additive consists in that the increase in weight of the filter candle elements due to the additive accumulated is limited. It is thereby guaranteed that the advantage of the stabilizing effect of the additive accumulated to the inorganic fibers outweighs the disadvantage of additional weight load.

In an especially preferred embodiment of the filter candle element according to the invention the mineral additive comprises zeolite. Zeolite has a high structural chemical similarity with the inorganic fibers. This accounts for a mutual affinity. For this reason, the zeolite is especially uniformly accumulated to the inorganic fibers. A virtually complete bonding of the zeolite to the fiber matrix takes place. Another advantage of zeolite lies in its chemical and thermal stability, which is comparable to the stability of the inorganic fibers. For this reason, even under operating conditions, zeolite is chemically and thermally stable and remains unchanged in the filter body. An additional advantage of zeolite is that it is a substance with a closely specified and reproducibly available dimensioning and characteristic.

Preferably, the zeolite is selected from zeolites of the beta-(BEA-) type, pentasil-(MFI-) type, mordenite-(MOR-) type, LiLSX-(FAU-) type, chabasite-(CHA-) type, erionite-(ERI-) type, Linde-type-L-(LTL-) type, brewsterite-(BRE-) type.

According to another aspect of the invention the zeolite is doped with a catalytically active component. A catalytically active component preferably comprises a catalytically active metal or a catalytically active precious metal or metal compound, preferably iron, cobalt or copper.

The gases produced in industry may have temperatures of up to 1000° C. Numerous industrial applications having high process temperatures, such as occurring in melting, fuel firing and calcination plants, additionally frequently generate high concentrations of nitrogen oxides (NOₓ) in the flue or waste gas. It is known that the NOₓ reduction (denitrification) can take place by a so-called selective catalytic reduction reaction (SCR). In this reaction the nitrogen oxides are converted to molecular nitrogen (N₂) and water (H₂O) by using ammonia (NH₃) or urea (CH₄N₂O) in the presence of a catalyst. The rate of the reduction reaction with a given catalyst depends on the ratio NO₂ to NOₓ. In the case of so-called fast SCR NO₂ and NO are present in the gas in equal parts. It is known that the filter candle elements are subsequently impregnated with metal salt solutions containing a catalytically active component. In particular, vanadium pentoxide (V₂O₅), tungsten oxide (WO₃), and titanium dioxide (TiO₂) (so-called VWT catalysts) have become established as catalytically active components. A disadvantage of the above cited catalysts is found to be their toxicity and poor environmental compatibility. Another disadvantage in connection with the above cited known catalysts is that their catalytic activity decreases at temperatures above 500° C.

Zeolites include pore, cage and channel structures. Catalytically active components may be become deposited and retained in the structures. The catalytically active components are then immobilized in the filter body. The use of a catalytically active component in the zeolite has the advantage that said reduction reaction is accelerated. When using zeolite with a catalytically active component as a catalyst in the SCR reaction, nitrogen monoxide (NO) is first oxidized into nitrogen dioxide (NO₂). This may favor the ratio NO₂ to NOₓ determining the rate of the subsequent reduction reaction. In addition, zeolites doped with catalytically active components may also be used at high operating temperatures due to their chemical and thermal stability. Another advantage is that the zeolites with accumulated catalytic components are environmentally compatible and non-toxic.

The method of the invention of manufacturing the above-described filter candle elements for the dedusting of industrial gases comprises the following steps:

producing a slurry comprising inorganic fibers, preferably mineral fibers, high-temperature wool, vitreous fibers, AES fibers or carbon fibers, and a mineral additive, preferably silica sand, rock flour, lime or zeolite. Furthermore, sucking in the slurry onto a suction core to form the filter candle element; drying the formed filter candle element.

Due to the fact that in addition to the inorganic fibers the slurry comprises a mineral additive, the strength and compression stability of the filter body is increased. In particular, its radial compression stability and its bending moment in the longitudinal direction are increased. This is due to the fact that the mineral additive is uniformly accumulated to the inorganic fibers in a water bath. Thereby, the fiber matrix is stiffened.

The production of the slurry preferably comprises the following steps: dispersion of the inorganic fibers and the mineral additive in powder form in a water bath; circulation of the slurry. The weight of the inorganic fibers and the mineral additive expediently amounts to about a total of between 1% and 5% of the total weight of the slurry. In addition, it is expedient to add starch and/or silica sol to the slurry. On the one hand, this causes an improved wetting of the fibers. On the other hand, the viscosity of the slurry may be adjusted. Due to the fact that the slurry is constantly circulated by e. g. suitable pumps, the fibers and the additive are kept in suspension and/or are prevented from sedimentation.

The suction core is used to form the filter. Expediently, the suction core has a metal frame construction. Preferably, the metal frame construction comprises a cylindrically formed porous cladding made of a perforated plate, for example. The metal frame construction forms exactly the later internal geometry of the filter chemical element to be produced. A negative pressure is applied to the suction core. Subsequently, it is slowly immersed into the water bath. In the water bath the slurry is sucked in by the negative pressure. Thereby, the contained fibers together with the accumulated additive are accumulated to the suction core and form a filter body with accumulated mineral additive. Expediently, the water is sucked off and separated through the porous cladding. Further fibers from the slurry are accumulated to the filter layer, as long as the negative pressure allows perfusion of the resulting filter body. Thus, a three-dimensional fiber matrix is built up. The wall thickness of the filter body may be adjusted by means of adjusting the suction time and the negative pressure. The amount of water sucked through may also serve as an indicator of the fiber matrix obtained in the filter body.

Expediently, the filter candle element is taken out of the bath after forming the desired fiber layer under negative pressure. In this connection, the filter candle element is partially dewatered and transferred to a drying tool for drying.

Advantageously, the mineral additive comprises zeolite. Zeolites are very easy to meter out and disperse in the water bath. Furthermore, they are accumulated to the inorganic fibers in the water bath in an extremely uniform manner. In addition, a part of the cavities in the fiber matrix is filled. This additionally contributes to stiffening the filter body. The zeolite was expediently doped with a catalytically active component prior to the production of the slurry. Due to the fact that zeolite doped with a catalytically active component is added to the slurry, the catalyst is added in one working step with the manufacturing method of the filter candle element. This constitutes an advantage as compared to known methods, such as the subsequent impregnation of the filter candle element with a catalyst. In addition to the above-described advantages resulting from the addition of a zeolite doped with a catalytically active component, the dispersion of the zeolite in the water bath causes that the catalytically active component is distributed extremely uniformly in the filter body. This has the advantage that the catalyst can act across the entire wall thickness of the filter body. Thereby, the conversion of NO to NO₂ can be increased. This has the advantage that the proportion of produced nitrogen oxides, which are reduced by the fast SCR, is increased.

Below, preferred exemplary embodiments of the present invention are described on the basis of the following figures, wherein:

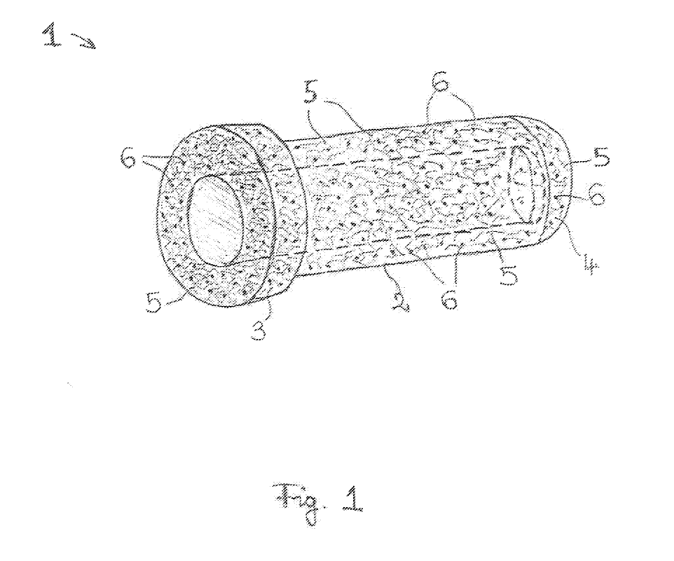

FIG. 1 shows a diagonal view of a filter candle element according to the invention;

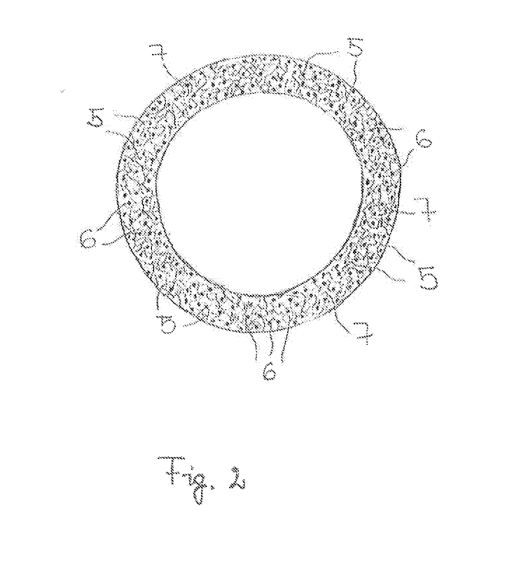

FIG. 2 shows a cross-section through a filter candle element according to the invention;

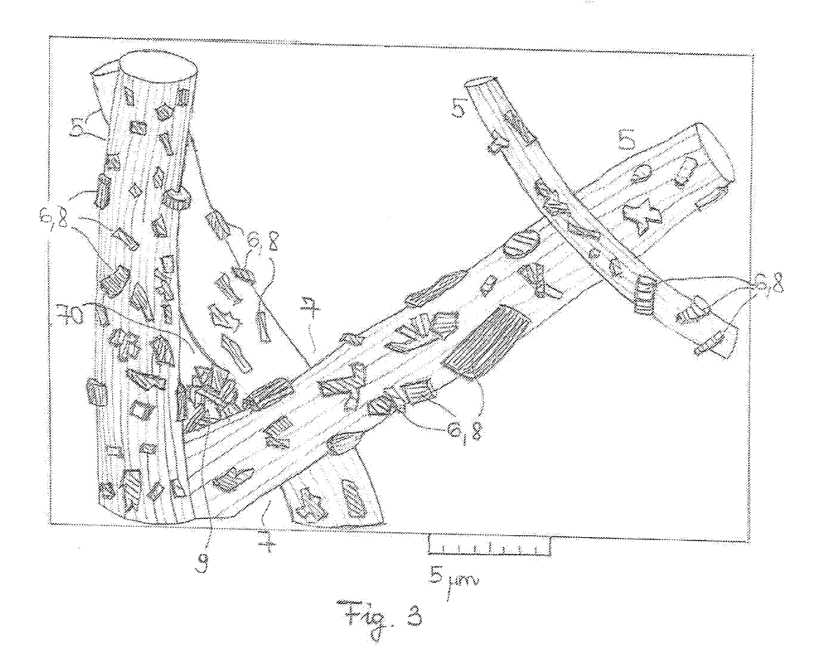

FIG. 3 shows a scanning electron microscope image of the inorganic fibers with accumulated mineral additive;

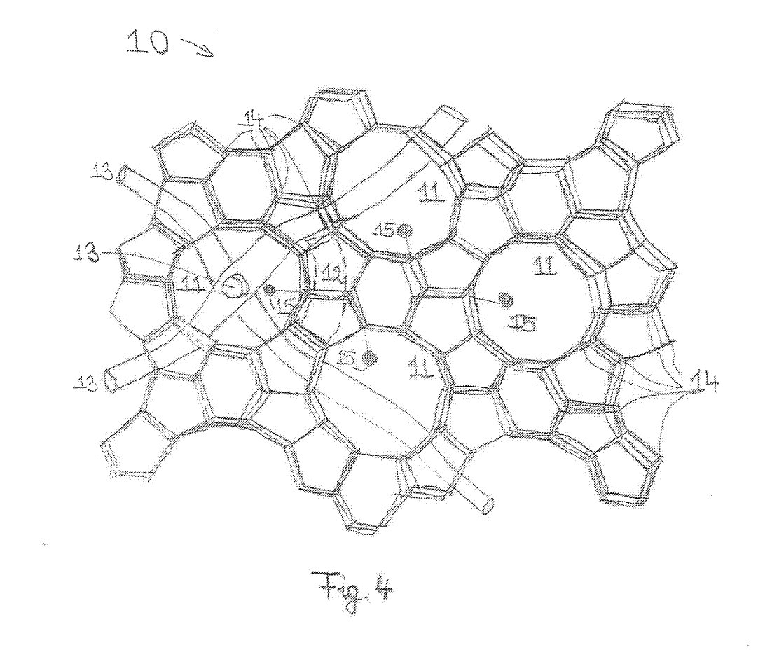

FIG. 4 shows a framework structure of zeolite (ZSM-5);

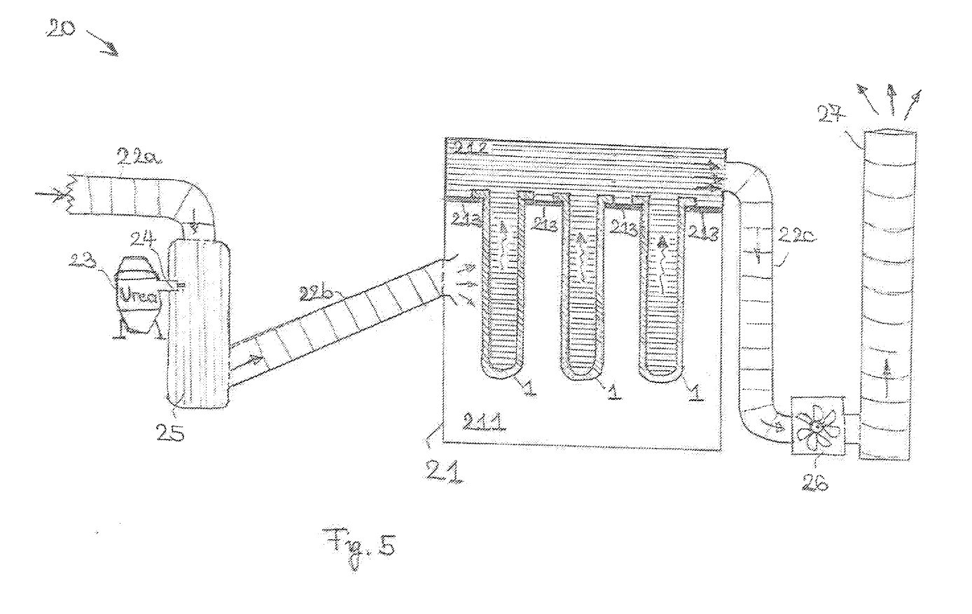

FIG. 5 shows a schematic view of an industrial filter system.

FIG. 1 shows a filter candle element 1 according to the invention, comprising inorganic fibers 5 and the mineral additive 6. The candle element 1 is designed in the shape of a hollow body. The shown filter candle element 1 comprises a central area 2. A collar 3 borders on the upper end of the central area 2. A bottom 4 borders on the lower end of the central area 2. The shown central area 2 is designed in the shape of a long hollow cylinder. The collar 3 likewise has the shape of a hollow cylinder. The height of this hollow cylinder is clearly smaller than the length of the central area 2. Furthermore, it can be recognized that the collar 3 projects outwards beyond the central area 2. The internal side of the collar 3 is flush with the internal side of the central area 2. Thus, the collar 3 has a greater wall thickness as compared to the central area 2. The upper end of the central area 2 and the collar 3 form a T-shaped collar area. The T-shaped design of the collar area has several advantages. For one thing, the filter candle element 1 can be inserted in the end plate of a filter system. Due to the T-shaped design of the collar area it is further achieved that the filter candle element 1 is more resistant to bending moments and bending stresses in the clamping area. The bottom 4 is designed as a spherical cap. The latter is flush with the central area 2 both on the inside and the outside. The filter candle element 1 is closed on its lower end by means of the bottom 4. In a preferred exemplary embodiment, the central area 2, collar 3 and bottom 4 of the filter candle element 1 are designed as one piece. The advantage of this is that crude gas cannot penetrate through possible transitions between the three areas 2, 3, 4 into the interior of the filter candle element 1.

The shown filter candle element 1 comprises inorganic fibers 5 forming a filter body. Expediently, the filter body has a porous structure. Dust particles contained in the crude gas can be retained or accumulated to the filter body upon passage through the filter candle element 1. Preferably, the inorganic fibers 5 are mineral fibers, high-temperature wool, vitreous fibers or carbon fibers.

In addition to the filter body the shown filter candle element 1 comprises a mineral additive 6. Preferably, silica sand, rock flour, lime or zeolite is used. According to the invention, the mineral additive 6 is accumulated to the inorganic fibers 5. This deposition leads to a stiffening of the fiber matrix, in which the inorganic fibers 5 are arranged. The advantage thereof is that the strength and compression stability of the filter body is increased. In particular, the radial compression stability of the filter body and the bending moment of the filter body are increased in the longitudinal direction. In another exemplary embodiment according to the invention it is also possible that the filter candle element 1, in addition to the filter body composed of inorganic fibers 5 and the mineral additive 6, also includes a reinforcing element which is embedded in the filter body. The reinforcing element may preferably be made of metallic foam, a perforated plate, a wire grating or an expanded metal. An additional reinforcing element may contribute to further increase the stability of the filter candle element 1.

FIG. 2 shows a cross-section of the filter candle element 1 according to the invention of FIG. 1. Here, it may be a cross-section of the central area 2, but also of the collar 3 or the bottom 4. The cross-section has the shape of a circular ring. Moreover, the inorganic fibers 5 are shown. In part they lie on top of each other; in part they are interwoven with each other. The three-dimensional interwoven structure, comprising the inorganic fibers 5 as struts and the shown cavities 7, constitutes the so-called fiber matrix. The fiber matrix forms the porous structure of the filter body. Furthermore, the fine-particle mineral additive 6 is shown. It is distributed uniformly over the fiber matrix. For example, the mineral additive 6 may be present in powder form. FIG. 2 shows the individual powder particles. Furthermore, it is shown that the mineral additive 6 fills up part of the cavities 7 of the fiber matrix. Thereby, the filter body is additionally stiffened.

The amount of added mineral additive 6 defines the increase in the stability of the filter body. It is expedient if the weight of the mineral additive 6 in the filter candle element 1 amounts to about 1% to 8% of the weight of the filter body. This is to say that the percentage by weight of the mineral additive 6, on the one hand, and that of the inorganic fibers 5, on the other hand, is preferably at a ratio from 0.01:1 to 0.08:1 in the filter candle element 1. It is particularly preferred that the weight of the mineral additive 6 in the filter candle element 1 amounts to about 2% to 6% of the weight of the filter body. The selected ranges of quantities added are selected such that, on the one hand, a significant increase in the stability of the filter body, preferably of its radial compression stability and its bending moment in the longitudinal direction is noticeable. On the other hand, limiting the quantity of added mineral additive 6 serves the purpose of minimizing the disadvantages in the pressure loss behavior of the filter candle element 1 as much as possible. The addition of the mineral additive 6 basically reduces the porosity and air permeability of the filter candle element 1. A porosity of at least 80% is advantageous for the filter candle element 1 according to the invention. Such a porosity is achieved for the cited quantities added. Lower porosities would result in a considerably increased pressure loss. In addition, limiting the quantity of the added mineral additive 6 to the above cited ranges has the advantage that the increase in weight of the filter candle element 1 is limited due to the higher density. Thus, less additional weight must be borne by the end plate of the filter system.

FIG. 3 shows a scanning electron microscope image of inorganic fibers 5 in a filter candle element 1 according to the invention. The image is an example of a section of the fiber matrix. The mineral additive 6 is accumulated to the inorganic fibers 5. Four inorganic fibers 5 can be seen in the section. The shown fibers have different thicknesses. The fibers 5 lie partially on top of each other. Furthermore, several cavities 7, 70 are shown. The fibers 5 and the cavities 7, 70 build up the porous interwoven structure (fiber matrix) of the filter body, as already described in connection with FIG. 2. Different-sized fragments 8 made of the mineral additive 6 are accumulated to the fibers 5. In a cavity 70 a deposition 9 of several fragments 8 made of a mineral additive 6 is shown. The cavity 70 is formed by three fibers 5 lying on top of each other. The fragments 8 have different shapes. For example, fragments 8 are shown in the shape of platelets and little rods of different dimensions. Finally, FIG. 3 is provided with a scale. The thickness of the fibers 5 is in the range of a few micrometers. The dimensions of the fragments 8 are in the range from a few tenths of a micrometer up to few micrometers. The length of the fibers 5 is in the range from 50 μm to 1 mm.

FIG. 3 shows that the fragments 8 are uniformly accumulated to the fibers 5. The term “uniformly” in this connection also includes the random distribution of a plurality of fragments 8 of different sizes and shapes on the surface of the fibers 5. This results in a stiffening of the fiber matrix. This increases the stability of each individual fiber 4 and thus also the stability of the filter body. For example, the fragments 8 may correspond to the powder particles of a mineral additive 6 available in powdered form. Further fragments 8 may be accumulated to the fragments 8 accumulated already to the fibers 5, preferably at locations where fibers 5 are lying directly on top of each other or contact each other. This results in depositions 9 of fragments 8. These depositions 9 project into the cavities 7, 70 of the three-dimensional fiber matrix. Thus, they fill up part of the cavities 7, 70. In addition, this results in a stiffening of the filter body.

In a particularly preferred exemplary embodiment of the filter candle element 1 according to the invention, the mineral additive 6 comprises zeolite. Zeolites are crystalline tectosilicates.

FIG. 4 shows the framework structure 10 of a zeolite. It has characteristic uniform pores 11, cages 12 and channels 13. In the shown example, the pores 11 have a decagonal structure. Because of this structure the pores 11 have a considerably larger diameter than the shown pentagonal and hexagonal structures. Cages 12 are partially formed from the pentagonal and hexagonal structures. As indicated by the dashed line in FIG. 4, for example, a cage 12 may extend over several pentagonal and/or hexagonal structures. In addition, the course of the channels 13 is indicated. Finally, cations 15 are shown. They ensure the electric charge neutrality of the zeolite.

The realization of the framework structure 10 will be explained in more detail below. The chemical composition of the zeolites will be described by the following chemical formula: Mⁿ⁺_{x/n} [(AlO₂)ₓ—(SiO₂)_{y}].wH₂O. It follows therefrom that zeolites are composed of SiO₄— or AlO₄ tetrahedrons. Therefore, zeolites are aluminosilicates. These tetrahedrons are connected to one another via all four oxygen atoms. One of these tetrahedrons is situated at each corner 14 of the polygons shown in FIG. 4. Thereby, a microporous framework structure 10 is created. For this reason, zeolites belong to the substance class of tectosilicates. Depending on the type of zeolite a characteristic structure made of pores 11, cages 12 and/or channels 13 is created. Due to the content of aluminum, zeolites have a negative framework charge. This negative charge is leveled out by cations Mⁿ⁺) 15. These may be enclosed in the defined pores 11, cages 12 and/or channels 13 of the framework structure 10. In naturally occurring zeolites these are cations 15 of the metals of the first and second main groups.

Depending on how the channels 13 are interconnected, zeolites are subdivided into three groups: zeolites having a one-dimensional channel system, which are characterized by channels 13 that are not interconnected; zeolites having a two-dimensional channel system, which are characterized in that the channels 13 are interconnected to form a layered system; zeolites having a three-dimensional channel system. In the present invention, from the first group, zeolites of the mordenite-(MOR-) type and the Linde-type-L-(LTL-) type are preferably used; from the second group zeolites of the brewsterite-(BRE-) type are used; from the third group, zeolites of the beta-(BEA-) type, pentasile-(MFI-) type, LiLSX-(FAU-) type, chabasite-(CHA-) type, erionite-(ERI-) type are used.

The framework structure 10 shown in FIG. 4 corresponds to a zeolite of the MFI-type (ZSM-5-type). The shown zeolite also belongs to the group of zeolites with a three-dimensional channel system. As indicated in FIG. 4, the system of pores 11 is connected by linear channels 13 and crossing, angled channels 13.

The cations 15 may be replaced by metals, metal compounds or precious metal compounds via the channels 13 of the zeolites. This takes place e. g. by means of ion exchange or chemical treatment. Preferably, doping takes place with copper, cobalt or iron, with copper, cobalt or iron compounds or with precious metal compounds. The cited substances and/or compounds are retained or even embedded in the pores 11 and/or cages 12. As a result of such doping the zeolites may include a catalytically active component. This has the advantage that the filter candle element 1 according to the invention may be used for the catalytic denitrification of the crude gas. Thus, not only the effect of the increased strength may be reached, but also a catalytic function may be integrated in the filter candle element 1. The catalytically active centers are then immobilized in the filter candle element 1. An advantage is that the addition of the catalyst may take place in one working step with the manufacturing process of the filter candle element 1. The characteristic of zeolite of being able to include other compounds in its framework structure 10 remains unaffected even at temperatures of 600° C. This makes possible an unlimited use of zeolites as a carrier of catalytically active components, even at an increased permanent operating temperature.

FIG. 5 shows a schematic view of an industrial filter system 20 for the denitrification of industrial gases. A filter house 21, several pipelines 22a, 22b, 22c, a urea tank 23 with nozzle 24, a mixing tower 25, fan 26 and a vent 27 are shown. The crude gas side 211 is situated in the lower part of the shown filter house 21. A plurality of filter candle elements 1 is arranged there. The clean gas side 212 which is isolated from the crude gas side 211 is located in the upper part of the filter house 21.

First of all, the crude gas passes into the mixing tower 25 via the pipeline 22a. There, urea solution from a urea tank 23 is injected via a nozzle 24. The solution expediently contains 30% to 35%, preferably 32.5% urea (CH₄N₂O). As is shown, the cross-section of the mixing tower 25 is clearly larger than the cross-section of the pipelines 22a or 22b. This cross-sectional enlargement is necessary so that a sufficiently strong mixing of the crude gas with the urea solution can take place. The mixture is then introduced into the crude gas sides 211 of the filter house 21 via pipeline 22b. The length of pipeline 22b is chosen such that further mixing of the crude gas and the urea solution may take place. Additional mixers may also be expediently built into the filter system. The use of a urea solution has the advantage that the urea, as opposed to ammonia, is non-corrosive and non-toxic. The ammonia required for denitrification is generated by hydrolysis of the urea solution.

A plurality of filter candle elements 1 according to the invention is located on the crude gas side 211 of the filter house 21. Preferably, filter candle elements 1 with zeolite are used. Particularly preferably, zeolite which is doped with a catalytically active component is used. The filter candle elements 1 are clamped with their collar 3 in the end plate 213 of the filter house 21.

A negative pressure between 0.010 bar and 0.050 bar, expediently between 0.012 bar and 0.020 bar is produced on the clean gas side 212 of the filter house 21 by the fan 26. The mixture of crude gas and injected urea solution is sucked through the filter candle element 1 due to the pressure gradient between the crude gas side 211 and the clean gas side 212. As a result, the crude gas is dedusted on the filter body. In addition, the crude gas is denitrified by selective catalytic reduction (SCR). According to the invention, preferably zeolite is used as a catalyst for the SCR. It is particularly preferred that the zeolite itself is doped with a catalytically active component. The catalytically active component may cause an advantageous oxidation of nitrogen oxide (NO) into nitrogen dioxide (NO₂). After a significant portion, expediently about half of the NO has oxidized into NO₂, denitrification may take place by means of the so-called fast catalytic reduction (“fast SCR”). In this connection, using ammonia (NH₃) obtained from the urea solution, NO and NO₂ are reduced to molecular nitrogen (N₂) and water (H₂O) in the presence of the zeolite as the catalyst. The latter reaction preferably takes place via the framework structure 10 of the zeolite. The fast catalytic reduction favored by the catalytically doped zeolite takes place faster by an order of magnitude than the NO₂-poor SCR. On the crude gas side 211, the crude gas expediently has a temperature between 300° C. and 600° C., preferably between 350° C. and 450° C.

Finally, the dedusted and denitrified gas is conveyed through pipeline 22c and to vent 27 by means of the negative pressure produced by the fan 26. Finally, the dedusted and denitrified gas is discharged via the vent 27.

### LIST OF REFERENCE NUMERALS

1 filter candle element
2 central area
3 collar
4 bottom
5 inorganic fibers
6 mineral additive
7 cavity
70 cavity with deposition 9
8 fragments
9 deposition of fragments 8
10 framework structure of a zeolite
11 pores of the zeolite
12 cages of the zeolite
13 channels of the zeolite
14 corners of polygons
15 cations
20 industrial filter system
21 filter house
22a, b, c pipelines
23 urea tank
24 nozzle
25 mixing tower
26 fan
27 vent
211 crude gas side of filter house 21
212 clean gas side of filter house 21
213 end plate

1. A filter candle element for the dedusting of industrial gases, comprising:
a filter body which is composed of inorganic fibers, and
a mineral additive which is accumulated to the inorganic fibers.

2. The filter candle element according to claim 1, wherein the inorganic fibers are arranged in a fiber matrix.

3. The filter candle element according to claim 2, wherein the mineral additive is evenly distributed in the fiber matrix.

4. The filter candle element according to claim 1, wherein the mineral additive has a weight accounting for 1% to 8% of the weight of the filter body.

5. The filter candle element according to claim 1, wherein the mineral additive comprises zeolite.

6. The filter candle element according to claim 5, wherein the zeolite is doped with a catalytically active component.

7. The filter candle element according to claim 6, wherein the catalytically active component comprises a catalytically active metal or a catalytically active metal compound.

8. A method of manufacturing a filter candle element for dedusting industrial gases, comprising the following steps:
producing a slurry comprising inorganic fibers and a mineral additive;
sucking in the slurry onto a suction core to form the filter candle element; and
drying the formed filter candle element.

9. The method of manufacturing a filter candle element according to claim 8, wherein the production of the slurry comprises the following steps:
dispersion of the inorganic fibers and the mineral additive in powder form in a water bath; and
circulation of the slurry.

10. The method of manufacturing a filter candle element according to claim 8, wherein the mineral additive comprises zeolite, which was doped with a catalytically active component prior to the production of the slurry.
